(19) United States
(12) Patent Application Publication
(10) Pub. No.: US 2013/0222277 A1
(43) Pub. Date: Aug. 29, 2013

(54) SYSTEMS AND METHODS FOR IDENTIFYING A USER OF AN ELECTRONIC DEVICE

(71) Applicant: James Michael O'Hara, Rockville Centre, NY (US)

(72) Inventor: James Michael O'Hara, Rockville Centre, NY (US)

(21) Appl. No.: 13/473,361

(22) Filed: May 16, 2012

Related U.S. Application Data
(60) Provisional application No. 61/602,426, filed on Feb. 23, 2012.

(51) Int. Cl. G06F 3/041

(52) U.S. Cl. 345/173

(57) ABSTRACT

Systems and methods for identifying a user of an electronic device are disclosed. An example method includes capturing a physical characteristic of a hand of a user via a sensor on a computing device. The characteristic is captured as the user touches the computing device for a purpose different from user identification. The example method includes determining an identifier associated with the user based on the captured characteristic.

### RELATED APPLICATION

This patent claims priority to U.S. Provisional Application Ser. No. 61/602,426, entitled “Systems and Methods for Identifying a User of an Electronic Device,” which was filed on Feb. 23, 2012, and is hereby incorporated herein by reference in its entirety.

### FIELD OF THE DISCLOSURE

This patent relates generally to audience measurement, and, more particularly, to systems and methods for identifying a user of an electronic device.

### BACKGROUND

Audience measurement of media, such as television, radio, and/or Internet content or advertisements, is typically carried out by monitoring media exposure of panelists that are statistically selected to represent particular demographic groups. Using various statistical methods, the collected media exposure data is processed and extrapolated to determine the size and demographic composition of the overall audience(s) of media (e.g., content and/or advertisements). The audience size and demographic information is valuable to advertisers, broadcasters and/or other entities. For example, audience size and demographic information is a factor in the placement of advertisements, as well as a factor in valuing commercial time slots during particular programs and/or content.

In recent years, methods of accessing media via the Internet, for example, have evolved. For example, Internet media was formerly primarily accessed via computer systems such as desktop and laptop computers. Recently, handheld devices (e.g., smartphones and tablets such as the Apple® iPad) have been introduced that allow users to request and view Internet media via a wireless access network.

### BRIEF DESCRIPTION OF THE DRAWINGS

FIG. 1 illustrates an example system to monitor computing device activity and identify users of the computing device.

FIG. 2 illustrates an example implementation of the computing device of FIG. 1.

FIG. 3 illustrates an example implementation of the user identification logic of FIG. 2.

FIG. 3A illustrates an example image of a fingerprint captured by the example user identification logic of FIG. 3.

FIG. 3B illustrates example images of fingertips captured by the example user identification logic of FIG. 3.

FIG. 4 is a flow diagram representative of example machine readable instructions that may be executed to implement the example computing device of FIG. 2 and the example user identification logic of FIG. 3 to register a user for participation in an audience measurement panel.

FIG. 5 is a flow diagram representative of example machine readable instructions that may be executed to implement the example computing device of FIG. 2 and the example user identification logic of FIG. 3 to identify a user participating in an audience measurement panel.

FIG. 6 is a flow diagram representative of example machine readable instructions that may be executed to implement the example computing device of FIG. 2 to collect activity data for audience measurement.

FIG. 7 is a block diagram of an example processor platform that may be used to execute the instructions of FIGS. 4, 5, and/or 6 to implement the example computing device of FIG. 2, the example user identification logic of FIG. 3, and/or, more generally, the example system of FIG. 1.

### DETAILED DESCRIPTION

Advertisers, manufacturers, content providers, and/or audience measurement companies desire to gain knowledge on how users interact with their handheld computing devices such as smartphones and tablets. To gain such knowledge, audience measurement companies enlist persons to participate in audience measurement panels. Such persons agree to allow the audience measurement company to monitor activities on their computing devices (e.g., Internet traffic to and/or from the devices) to, among other things, monitor exposure to media (e.g., content and/or advertisements), determine advertisement effectiveness, determine user behavior, identify purchasing behavior associated with various demographics, etc. Audience measurement data includes two primary components, namely, media identification data (e.g., data that identifies or can be used to identify media to which an audience was exposed), and people meter data (e.g., data that identifies or can be used to identify the person(s) in an audience). The people meter data is important because it enables the audience measurement entity to match demographics to the media identified by the media identification data.

People metering can be active or passive. In passive people metering, electronics are provided to automatically identify the user through, for example, facial recognition using video cameras. In active people metering, audience members are prompted to self-identify at various times. Such self-identification may involve pressing a button associated with the identity of the user or otherwise entering data (e.g., a user identifier) identifying the person(s) in the audience. Active people metering suffers from several shortcomings. For example, panelists may become wearied or irritated by the prompting and, thus, either fail to comply or drop out of the panel. In the context of computers such as personal computers, tablets, smart phones, etc., a panelist may log into the device to self-identify and then fail to log out. A second user may then begin utilizing the device, thereby misallocating the media exposures of the second user to the first user and introducing inaccuracies into the audience measurement data. This problem is particularly acute in the tablet context, where multiple members of a household may use the same tablet (e.g., Apple® iPad) at different times.

Example methods, systems, and/or computer readable storage media disclosed herein provide new techniques for passive people metering of devices with touchscreens such as phones and tablet computers. For instance, some disclosed example methods include capturing characteristic(s) of a hand of a user via a sensor on a computing device. The characteristic(s) are captured as the user touches the computing device for a purpose different from user identification. Some such disclosed example methods include determining an identifier associated with the user based on the captured characteristic(s). Some such disclosed example methods include exporting the identifier to a collection site.

Some example computing devices include a sensor to capture characteristic(s) of a hand of a user. The characteristic(s) are captured as the user touches the computing device for a purpose different from user identification. Some such example devices include user identification logic to determine an identifier associated with the user based on the captured characteristic(s). Some such example devices include an exporter to export the identifier to a collection site.

Some disclosed example tangible computer-readable storage media include instructions that, when executed, cause a computing device to at least capture characteristic(s) of a hand of a user via a sensor on a computing device. The characteristic(s) are captured as the user touches the computing device for a purpose different from user identification. The instructions of some such examples cause the computing device to determine an identifier associated with the user based on the captured characteristic. The instructions of some such examples cause the computing device to export the identifier to a collection site.

Example computing devices disclosed herein automatically identify a user so that the user may be associated with activity data (e.g., media identification data) collected during the user's interaction with the computing device. In disclosed examples, the identity of the user is determined as the user touches the computing device for a purpose different from user identification. Such examples enable passive user identification (e.g., the user is not required to actively identify himself). For example, a user's activities (e.g., websites visited, games played, media viewed, etc.) on a computing device are monitored and, as the user is involved in such activities, the identity of the user is determined with less need for repeatedly prompting the user and/or, in some examples, without prompting the user during the activity session.

In disclosed examples, users are registered. During registration, hand characteristics of the user are captured on the computing device using a plurality of sensors. Hand characteristics include, for example, a fingerprint, multiple fingerprints, shape(s) of the end(s) (or other portion(s)) of one or more finger(s), size(s) of the end(s) or other portion(s) of one or more finger(s), a palm print, a typing sample, etc. The end(s) of the finger(s) may be fingertips. The computing device stores these hand characteristics in association with a user identifier. The hand characteristics stored during registration are used to automatically identify the user as he/she operates the computing device. As the user uses the computing device, the computing device collects data related to the user's activities (e.g., media identification information) and also collects hand characteristics of the user using the plurality of sensors. User identification logic on the computing device or on a remote computing device such as a server at the central facility of an audience measurement entity compares the collected hand characteristics to the stored hand characteristics to identify the user. The user identifier is associated with corresponding collected activity data (e.g., media identification data) and/or is sent to a collection facility for further processing.

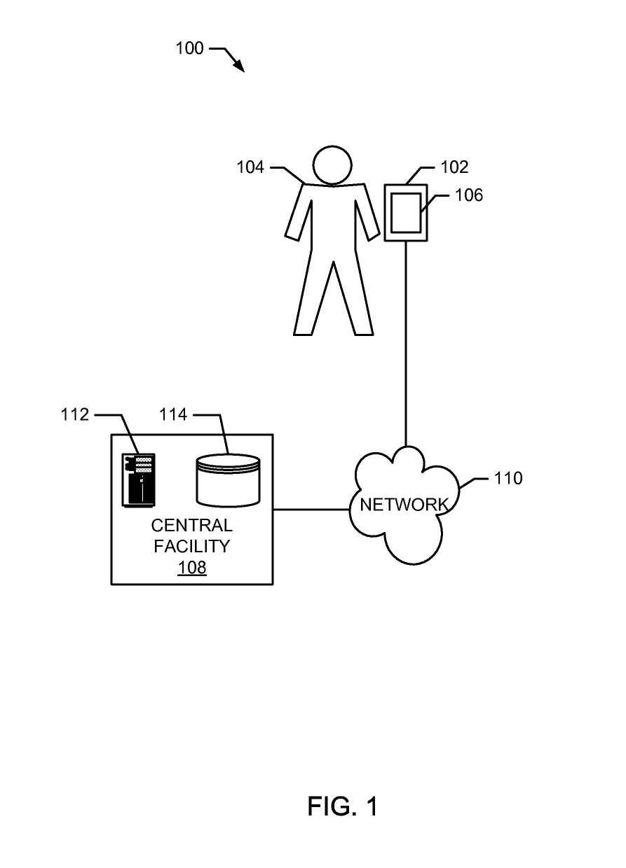

FIG. 1 illustrates an example system 100 to monitor activity at a computing device 102 and/or to identify a user 104 of the computing device 102. In the illustrated example, the computing device 102 is provided with a software meter to monitor and/or collect activity data (e.g., media identification data) related to, for example, Internet activity, application use, game play, messaging, etc. based on interaction of the user 104 with the computing device 102. Additionally, the computing device 102 of the illustrated example is provided with user identification logic to identify and/or to confirm the identity of a user (e.g., the user 104) of the computing device 102 so that the collected activity data is associated with the appropriate user.

In the illustrated example, the user 104 has volunteered, has been selected and/or has agreed to participate in an audience measurement system (e.g., the user 104 has agreed to the monitoring of his computing device 102 to collect activity data). In some examples, users (e.g., the user 104) may also agree to the monitoring of their media exposure activity within their homes (e.g., the monitoring of televisions, radios, computers, stereo systems, digital versatile disc (DVD) players, game consoles, etc.).

The computing device 102 of the illustrated example is a handheld device that is operated by the user 104 via a touchscreen 106. The computing device 102 may be any computing device that includes a touchscreen (e.g., a tablet (e.g., an Apple® iPad), a smartphone (e.g., an Apple® iPhone), etc.). Additionally or alternatively, the computing device 102 may be any device that operates using touchless touchscreen technology. Touchless touchscreen technology allows users to operate computing devices as they would with traditional touchscreens, but does not require users to actually touch the screens.

In the illustrated example, when the user 104 agrees to participate in the audience measurement system, the user 104 is asked and/or required to complete a registration process. During the registration process, the user 104 is prompted to enter a user identifier via the touchscreen 106. The user 104 may be asked and/or prompted via a display on the touchscreen 106, audible instructions output by a speaker, flashing lights, etc. The user identifier may be a name, an identification code (e.g., a series of letters and/or numbers), a birth date, and/or any other input that may be used to identify the user 104. Identifiers may be selected by users (e.g., the user 104) during registration or may be assigned to users by the audience measurement entity when they agree to participate in the audience measurement panel. Once the user 104 has entered the identifier, the user 104 is prompted to enter one or more hand characteristics via the touchscreen 106. For example, the user 104 may be asked to input a fingerprint, multiple fingerprints, a typing sample (e.g., from which fingertip shape(s) and/or usage characteristic(s) may be collected), etc. using the touchscreen 106 of the computing device 102. The computing device 102 of the illustrated example includes sensor(s) (e.g., located behind the touchscreen and sending data thru the touchscreen (or touchless screen)) to capture the hand characteristics as the user 104 interacts with the touchscreen 106. For example, the computing device 102 includes image sensor(s) (e.g., a digital camera) to capture the fingerprint and/or other hand characteristics of the user 104. The computing device 102 may analyze the captured hand characteristic(s) (e.g., the fingerprints, the shape of the fingertip(s) touching the touchscreen or operating the touchless screen, etc.) to determine identifiers that may be associated with the user 104. For example, the computing device 102 may capture a fingerprint, may determine a size of the fingertip and/or a shape of the fingertip, etc. In some examples, the computing device 102 analyzes a typing sample input by the user 104 to determine a typing cadence and/or a typing pattern (e.g., a number of fingers used to type) to be associated with the user 104 and/or to collect the fingerprint and/or fingertip characteristics.

Once the computing device 102 has collected hand characteristic(s) of the user 104, the computing device 102 stores the hand characteristic(s) in association with the identifier of the user 104. For example, the computing device 102 may store the identifier (e.g., an alphanumeric identifier unique to the user such as a username) along with the hand characteristics (e.g., a fingerprint, a fingertip size, a fingertip shape) and/or usage patterns (e.g., a typing cadence and/or a typing pattern) representative of the user 104. The registration process may be complete upon the association of hand characteristic(s) with an identifier of the user 104 or the registration process may include additional steps such as prompting the user to input demographic information, etc. The hand characteristic(s) and/or usage pattern(s) of the user 104 are used by the computing device 102 to identify the user 104 as the user 104 interacts with the computing device 102 for other purposes (e.g., for a purpose different from user identification). Thus, the user is passively identified without the need for excessive prompting the user to engage in self-identification (e.g., logging in).

Identifying the user 104 is important in the context of audience measurement to ensure that data collected on the computing device 102 is associated with the appropriate person (e.g., the person interacting with the computing device 102) and, thus, the correct demographics. Often times, a computing device such as an iPad may be used by multiple members of a household at different times. In such examples, the computing device 102 collects activity data that is then associated with the corresponding member(s) of the household (e.g., the household member(s) interacting with the computing device 102). Identifying users by their hand characteristic(s) and/or their usage pattern(s) as they interact with the computing device 102 facilitates such associations. Furthermore, capturing hand characteristics of users as they interact with the computing device 102 for other purposes is a nonintrusive method for identifying users. Such nonintrusive methods are less reliant on user compliance and may increase the likelihood of a person agreeing to and/or continuing to participate in an audience measurement panel.

After or during the registration, the panelist is provided with a meter to track activity on the computing device and to identify users of the computing device. In the illustrated example, the meter is a software meter that is downloaded to the computing device to be monitored via, for example, the Internet. The meter runs in the background of the monitored device to identify and record events/activities of interest occurring on the device. There are numerous manners of implementing meters to identify activities on a computing device. Any such technique of collecting activity data may be employed. For an example of a software meter monitoring activity on a computing device, see Coffey, U.S. Pat. No. 5,675,510, which is hereby incorporated by reference in its entirety. Methods of collecting activity data are, thus, beyond the scope of this disclosure and will not be discussed in great detail herein.

The software meter running on the computing device 102 monitors activity of the user 104 on the computing device 102. The meter of the computing device 102 may monitor, for example, Internet activity, data sent and/or received, games played, media viewed, applications downloaded, advertisements selected, etc. and create (e.g., collect) activity data (e.g., media identification data) representative of the user 104 activity. As the meter on the computing device 102 monitors these activities (e.g., as the user 104 operates the computing device 102), the meter running on the computing device 102 also detects hand characteristic(s) and/or usage patterns of the user 104. For example, as the user 104 types on the touchscreen 106 (or touchless screen) of the computing device 102 to, for example, perform an Internet search or interact with an application (e.g., an “app”), the meter collects data corresponding to fingerprint(s), fingertip shape(s), fingertip size(s), typing cadence(s), and/or typing pattern(s) using sensors within the computing device 102 (e.g., image sensor behind the touchscreen). The meter of the illustrated example collects hand characteristic(s) and/or usage patterns of the user 104 continuously. However, in other examples, the meter collects the hand characteristic(s) and/or usage pattern(s) periodically, aperiodically, and/or upon an occurrence of an event (e.g., after the computing device 102 has been powered on, after a new app has been opened, etc.).

The meter running on the computing device 102 identifies the user 104 by matching collected data representative of hand characteristic(s) with hand characteristic(s) stored in the computing device 102 (e.g., hand characteristics that were collected and associated with a user during the registration process) and/or by matching data representative of usage patterns with historical usage patterns stored in the computing device 102. The computing device 102 may associate collected activity data (e.g., media identification data) with the identified user 104 and/or may export the collected activity data and the user identification data to a central facility 108 for further processing and/or association. In the illustrated example, the collected activity data and/or user identifier(s) are timestamped and sent to the central facility 108 via the network 110. The timestamps facilitate matching users to activities and/or media.

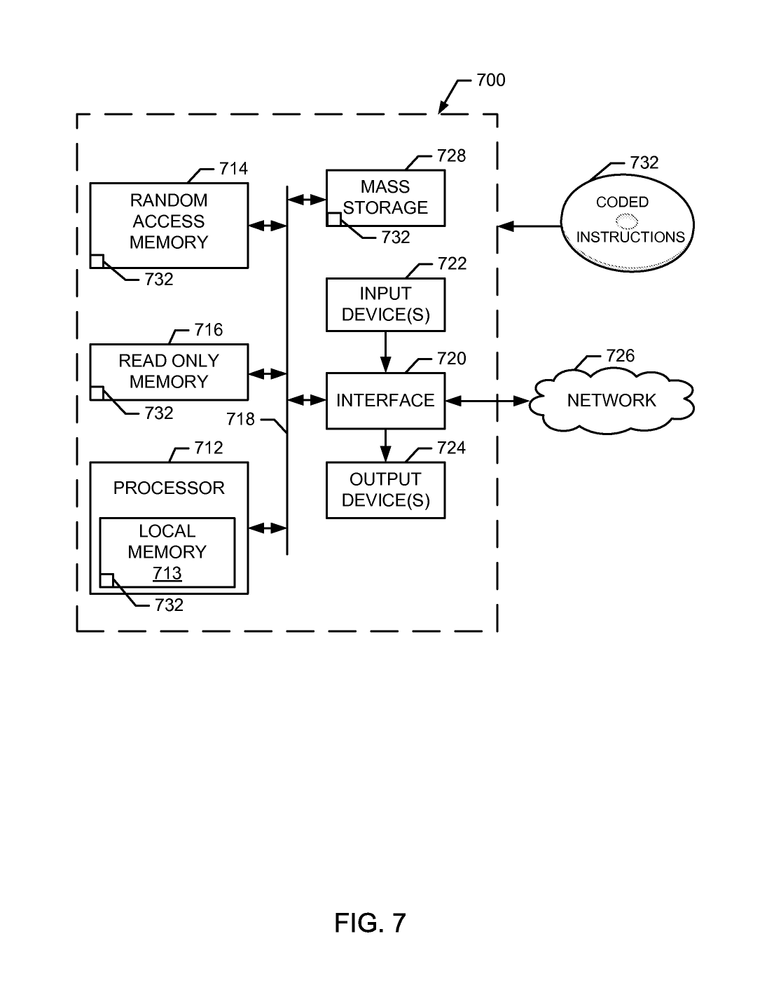

The central facility 108 of the illustrated example collects and/or stores, for example, media exposure data, user identification data and/or demographic information that is collected for multiple users operating multiple computing devices by multiple media monitoring devices similar to, for example, the meter running on the computing device 102. The central facility 108 may be, for example, a facility associated with The Nielsen Company (US), LLC or any affiliate of The Nielsen Company (US), LLC. The central facility 108 of the illustrated example includes a server 112 and a database 114 that may be implemented using any suitable processor, memory and/or data storage apparatus such as that shown in FIG. 7.

The network 110 of the illustrated example is used to communicate information and/or data between the example computing device 102 and the central facility 108. The network 110 may be implemented using any type(s) of public and/or private network such as, but not limited to, the Internet, a telephone network (e.g., the plain old telephone service network (POTS), a local area network (LAN), a cable network, and/or a wireless network. The computing device 102 may communicate with the network 110 using a wireless or wired connection. For example, the computing device 102 may include a communication interface that enables connection to an Ethernet, a digital subscriber line (“DSL”), a telephone line, a coaxial cable, and/or any wireless connection, etc.

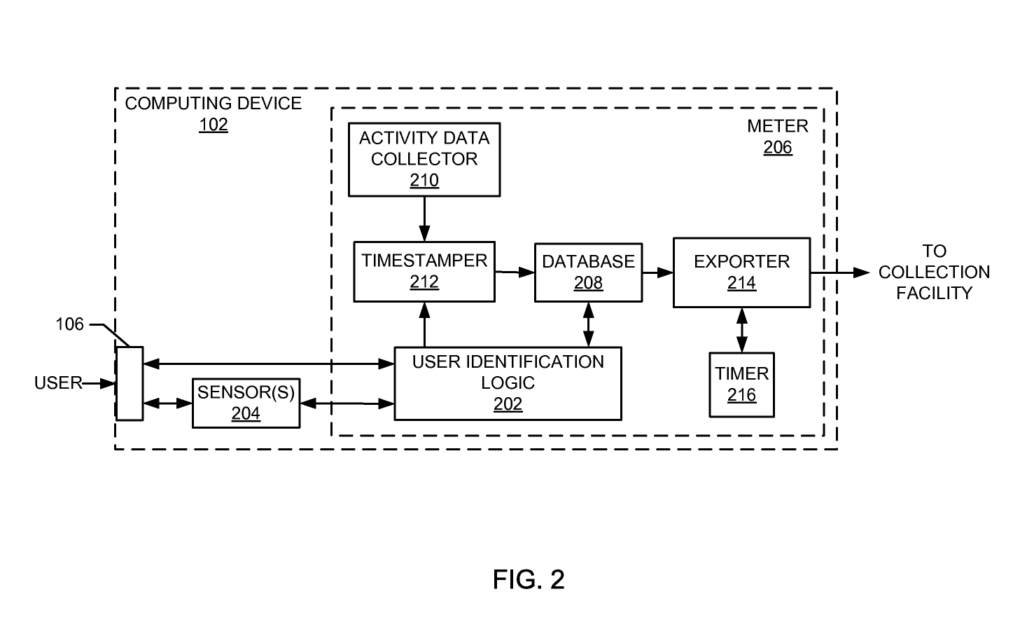

FIG. 2 is a block diagram of an example implementation of the example computing device 102 of FIG. 1 and the example meter 206 discussed above. FIG. 2 focuses on the meter 206 and, thus, omits much of the hardware of the computing device 102. A more complete illustration of the hardware of the computing device 102 is discussed below in connection with FIG. 7. In the illustrated example, the meter 206 collects activity data representative of a user's interaction (e.g., the user 104) with the computing device 102 and of the media to which the user is exposed during that interaction. The meter 206 of the illustrated example also automatically identifies the user 104 associated with the activity data by detecting hand characteristic(s) and/or usage pattern(s) as the user 104 interacts with the computing device 102. The data collected for user identification is collected while the user uses the device for a purpose different from self-identifying (e.g., during normal usage of the device). In the illustrated example, the computing device 102 includes the touchscreen 106 (or a touchless screen) and image sensor(s) 204. The meter 206 includes user identification logic 202, a database 208, an activity data collector 210, a timestamper 212, an exporter 214, and a timer 216.

The touchscreen 106 of the illustrated example allows the user 104 to operate the computing device 102 using touch. Touchscreens such as the touchscreen 106 are frequently used in computing devices (e.g., the computing device 102) as they allow for simple user interaction. The touchscreen 106 of the illustrated example is enhanced to include image sensors 204 behind the touchscreen to allow the user identification logic 202 to collect hand characteristic(s) and usage pattern(s) of the user 104 as the user 104 operates the computing device 102.

The user identification logic 202 of the illustrated example is used to identify the user 104 by collecting hand characteristics and usage patterns of the user 104 as the user 104 operates the computing device 102. When the user 104 agrees to participate in an audience measurement panel, the user 104 is required to complete a registration process. During the registration process, the user identification logic 202 prompts the user 104 (e.g., via display on the touchscreen 106, audible instructions output by a speaker, flashing lights, etc.) to input a user identifier. The identifier may be a name, an identification code (e.g., a series of letters and/or numbers), a birth date, and/or any other input that may be used to identify the user 104.

Once the user 104 has entered the identifier via the touchscreen 106, the user identification logic 202 prompts the user 104 to enter one or more hand characteristics. For example, the user identification logic 202 prompts the user 104 to touch the screen in various ways (e.g., to type a sample sentence to record finger arrangement, fingertip size, and/or finger placement during said typing, to place a finger on the sensor in a certain position, input a fingerprint, multiple fingerprints, etc.). The computing device 102 of the illustrated example includes sensor(s) 204 to capture the hand characteristics being input by the user 104 on the touchscreen 106. The sensor(s) 204 may include any number and/or type(s) of sensors to capture a fingerprint, multiple fingerprints, a typing sample, etc. The sensor(s) 204 may be, for example, image sensor(s) and/or a camera placed behind the touchscreen 106 to capture the hand characteristics of the user 104 through at least one layer of the touchscreen. Thus, the touchscreen of the illustrated example is at least partly transparent to enable the sensor(s) to read fingerprints through the screen.

The user identification logic 202 of the illustrated example analyzes the captured hand characteristic(s) to determine additional characteristics to be associated with the user 104. For example, the user 104 inputs a fingerprint (captured by the sensor(s) 204) and the user identification logic 202 analyzes the fingerprint to determine a size of the fingerprint and/or a shape of the fingerprint. In some examples, the user identification logic 202 analyzes a typing sample input by the user 104 to determine a typing cadence and/or a typing pattern to be associated with the user 104 and/or to detect the shape of the surface of the tips of the user's fingers that impact the screen when typing.

Once the user identification logic 202 has collected hand characteristic(s) entered by the user 104, the user identification logic 202 sends the hand characteristic(s), usage pattern(s), and the identifier entered by the user 104 to the database 208 for storage. The database 208 of the illustrated example stores the user identifier in association with the corresponding user hand characteristic(s) and/or the usage characteristic(s). For example, the database 208 of the illustrated example stores an identification code along with a fingerprint, a fingerprint size, a fingertip size, a fingertip shape, a typing cadence, and/or a typing pattern representative of the user 104. The registration process may be complete upon the association of hand characteristics and/or the usage characteristics with an identifier of the user 104 or the registration process may include additional steps such as prompting the user to input demographic information, etc. Subsequently, the user identification logic 202 uses the hand characteristic(s) and/or the usage characteristic(s) to identify the user 104 as the user 104 interacts with the touchscreen of the computing device 102.

The activity data collector 210 of the illustrated example monitors activity of the user 104 on the computing device 102. The activity data collector 210 may monitor, for example, Internet activity (e.g., uniform resource locators (URLs) requested, web pages visited, etc.), data sent and/or received, games played, media viewed, applications downloaded, advertisements selected, etc. The activity data collector 210 of the illustrated example collects data related to the activity of the user 104 and passes the collected activity data to the timestamper 212. The timestamper 212 of the illustrated example timestamps the collected activity data and passes the timestamped data to the database 208 for storage.

As the activity data collector 210 collects activity data representative of activity of the user 104 on the computing device 102 (e.g., as the user 104 operates the computing device 102), the user identification logic 202 detects hand characteristic(s) of the user 104 and/or usage characteristic(s) using the sensor(s) 204. For example, as the user 104 types on the touchscreen 106 of the computing device 102, the user identification logic 202 collects and/or determines a fingerprint, fingerprint size, fingerprint shape, fingertip shape, fingertip size, a typing cadence, and/or a typing pattern (e.g., using different sets of fingertips between key strokes, timing between key strokes, etc.) using the sensor(s) 204.

The user identification logic 202 of the illustrated example identifies the user 104 by matching collected hand characteristic(s) with hand characteristic(s) stored in the database 208 (e.g., hand characteristics that were collected and associated with a user during the registration process). The matching process may involve, for example, converting images into signatures and matching the signatures and/or representing the image(s) as vectors and matching the vectors. Any other image representation and/or matching technology(ies) may additionally or alternatively be used.

In some examples, the user identification logic 202 includes a plurality of counters to identify the user 104. For example, once the user identification logic 202 has collected hand characteristics of the user 104, the user identification logic 202 determines if a collected fingerprint is known. If a collected fingerprint is substantially similar, for example, to a stored fingerprint, the user identification logic 202 determines that the collected fingerprint is known and increments a fingerprint counter for a corresponding user. In some such examples, the user identification logic 202 additionally determines if a fingertip size and/or shape is known. If a collected fingertip size and/or shape is substantially similar to a stored fingertip size and/or shape, the user identification logic 202 determines that the collected fingertip size and/or shape is known and increments a fingertip size counter and/or a fingertip shape counter for a corresponding user. In some such examples, the user identification logic 202 additionally determines a typing cadence of the user 104 and determines if the typing cadence is known. If a determined cadence is substantially similar to a stored cadence, the user identification logic 202 determines that the determined typing cadence is known and increments a cadence counter for the corresponding user. In some such examples, the user identification logic 202 additionally determines a typing pattern of the user 104 and determines if the typing pattern is known. A typing pattern may be, for example, a number of fingers used by the user 104 to type on the touchscreen 106. If a determined pattern is substantially similar to a stored pattern, the user identification logic 202 determines that the determined typing pattern is known and increments a pattern counter for a corresponding user. Additional and/or alternative characteristic(s) and corresponding counters may be analyzed. For example, if users rest their hand on the sensors as they type, the size of the portion of the hand resting on the sensor may be detected and tracked as a hand characteristic.

In the illustrated examples, once the user identification logic 202 has evaluated the collected hand characteristics (e.g., the fingerprint, fingertip size/shape, typing cadence, typing pattern, etc.), the user identification logic 202 sums the counters of all characteristics for each corresponding user. Once the user identification logic 202 sums the counters for each corresponding user, the user identification logic 202 identifies the user 104 as the user with the highest total count. Once such an identification is made, the counters are cleared (e.g., zeroed) and another round of the counting begins to again seek to identify the user. Continuously attempting to identify the user in this manner ensures a transition from usage of the device by a first user for usage of the device by a second user is quickly detected and recorded.

Once the user identification logic 202 has identified the user 104, the user identification logic 202 passes the identifier of the user (e.g., a user name, identification code, number, birth date, etc.) to the timestamper 212. The timestamper 212 of the illustrated example timestamps the user identifier and passes the user identifier to the database 208 for storage.

The database 208 may associate collected activity data with the user identifier based on their respective timestamps and/or may pass the activity data and the user identifier separately to the exporter 214 to export the data to the central facility 108 for further processing and/or association. Collected activity data and/or user identifiers are sent to the central facility 108 via a network (e.g., the network 110 of FIG. 1).

The exporter 214 of the illustrated example uses the timer 216 to determine when to export data to the central facility 108. For example, the timer 216 may indicate that data should be exported every two hours. When two hours has elapsed, the exporter 214 exports any activity data and/or user identifiers collected and/or determined in that two hours. Alternatively, the data may be exported whenever an available collection is detected as described in U.S. Pat. No. 8,023,882, which is hereby incorporated by reference in its entirety.

While an implementation of the example computing device 102 has been illustrated in FIG. 2, one or more of the elements, processes and/or devices illustrated in FIG. 2 may be combined, divided, re-arranged, omitted, eliminated and/or implemented in any other way. Further, the touchscreen 106, the user identification logic 202, the sensor(s) 204, the meter 206, the database 208, the activity data collector 210, the timestamper 212, the exporter 214, the timer 216, and/or, more generally, the example computing device 102 of FIG. 2 may be implemented by hardware, software, firmware and/or any combination of hardware, software and/or firmware. Thus, for example, any of the example touchscreen 106, the user identification logic 202, the sensor(s) 204, the meter 206, the database 208, the activity data collector 210, the timestamper 212, the exporter 214, the timer 216, and/or, more generally, the example computing device 102 of FIG. 2 could be implemented by one or more circuit(s), programmable processor(s), application specific integrated circuit(s) (“ASIC(s)”), programmable logic device(s) (“PLD(s)”) and/or field programmable logic device(s) (“FPLD(s)”), etc. When any of the apparatus or system claims of this patent are read to cover a purely software and/or firmware implementation, at least one of the example touchscreen 106, the user identification logic 202, the sensor(s) 204, the meter 206, the database 208, the activity data collector 210, the timestamper 212, the exporter 214, and/or the timer 216 are hereby expressly defined to include a tangible computer readable medium such as a memory, DVD, compact disc (“CD”), etc. storing the software and/or firmware. Further still, the example computing device 102 of FIG. 2 may include one or more elements, processes and/or devices in addition to, or instead of, those illustrated in FIG. 2, and/or may include more than one of any or all of the illustrated elements, processes and devices.

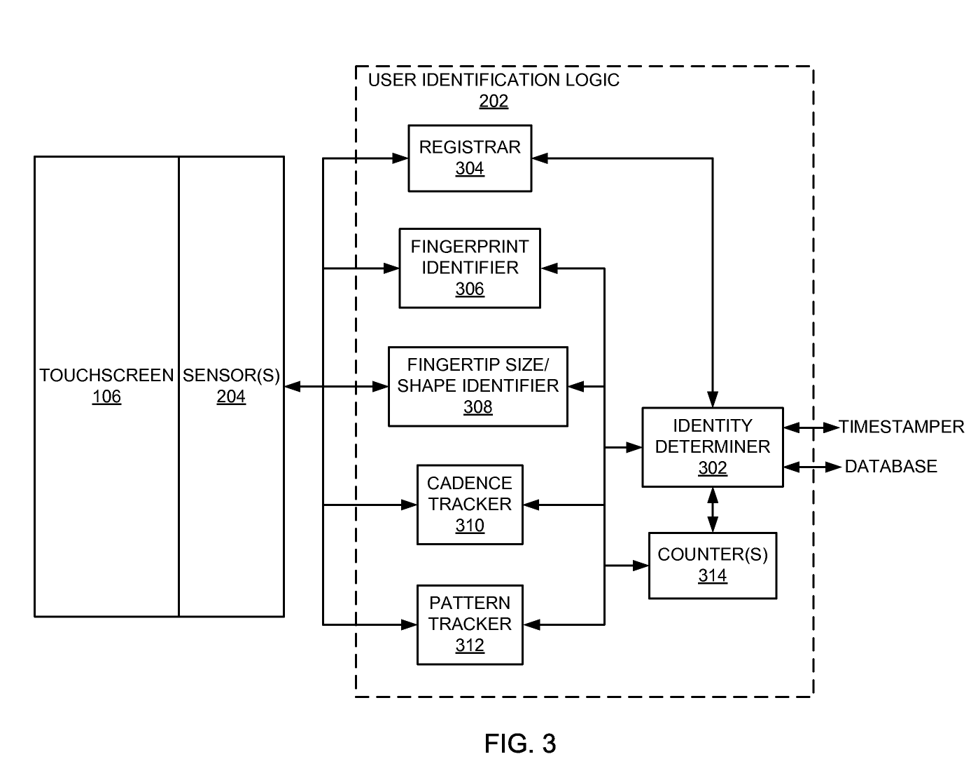

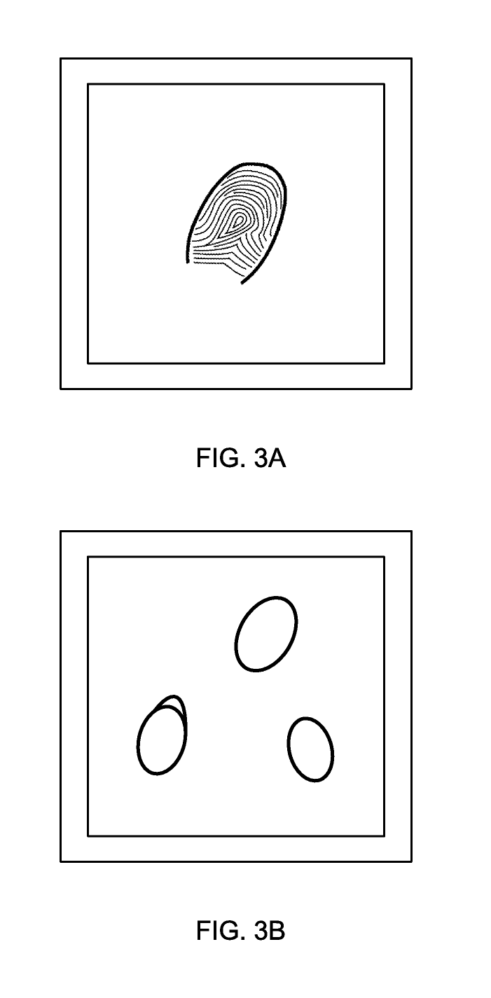

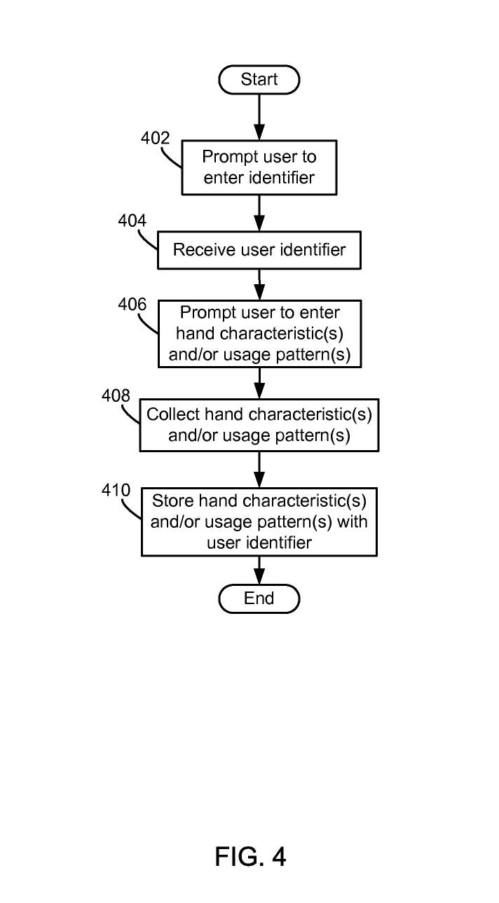

FIG. 3 is a block diagram of an example implementation of the user identification logic 202 of FIG. 2. In the illustrated example, the user identification logic 202 automatically identifies the user 104 of the computing device 102 as the user 104 interacts with the computing device 102 for a purpose different than user identification (e.g., web browsing, game playing, etc.). In the illustrated example, the user identification logic 202 includes an identity determiner 302, a registrar 304, a fingerprint identifier 306, a fingertip size/shape identifier 308, a cadence tracker 310, a pattern tracker 312, and counter(s) 314.

The identity determiner 302 of the illustrated example is used to identify the user 104 based on hand characteristic(s) and/or usage pattern(s) of the user 104 collected as the user 104 operates the computing device 102. When the user 104 agrees to participate in an audience measurement panel, the user 104 is required to complete a registration process. During the registration process, the registrar 304 prompts the user 104 (e.g., via display on the touchscreen 106, audible instructions output by a speaker, flashing lights, etc.) to input a user identifier. The identifier may be a user name, an identification code (e.g., a series of numbers), a birth date, and/or any other input that may be used to identify the user 104. The user 104 enters the identifier via the touchscreen 106 and the registrar 304 receives the identifier. The registrar 304 passes the identifier to the identity determiner 302 and the identity determiner 302 passes the identifier to a database (e.g., the database 208 of FIG. 2) for storage. In some examples, the registrar 304 assigns a username or identifier to the user and/or the registrar 304 is not part of the user identification logic 202, but instead is part of the central facility of the audience measurement entity.

Once the user 104 has entered the identifier via the touchscreen 106, the registrar 304 of the illustrated example prompts the user 104 to enter a fingerprint and a typing sample using the touchscreen 106 of the computing device 102. Sensor(s) (e.g., sensor(s) 204 of FIG. 2) are used to capture the hand characteristic(s) input by the user on the touchscreen 106. The fingerprint identifier 306, the fingertip size/shape identifier 308, the cadence tracker 310, and the pattern tracker 312 receive the captured fingerprint data, fingertip data, and/or typing sample from the sensor(s) 204 and analyze the captured hand characteristics to determine identifiers that may be associated with the user 104.

The fingerprint identifier 306 of the illustrated example determines the fingerprint of the user 104. An example fingerprint is illustrated in the example of FIG. 3A. As shown in FIG. 3A, during the registration process, the user may be instructed to touch a specific part of the sensor to facilitate a good fingerprint reading. The fingertip size/shape identifier 308 determines the size and/or shape of the portion of the user's fingers (e.g., the fingertip(s) of the user 104) that touch the touchscreen 106 during usage (e.g., during tapping, button selection, sliding, etc.). Example fingertip sizes and shapes are illustrated in the example of FIG. 3B. As shown in FIG. 3B, fingerprint size may in some instances include the size and/or shape of a fingernail (see the lower left image in FIG. 3B). The cadence tracker 310 of the illustrated example analyzes the typing sample to determine a typing cadence to be associated with the user 104. The pattern tracker 312 of the illustrated example analyzes the typing sample to determine a typing pattern to be associated with the user 104.

Once the fingerprint identifier 306, the fingertip size/shape identifier 308, the cadence tracker 310, and/or the pattern tracker 312 have collected and/or determined the hand characteristic(s) and/or usage pattern(s) entered by the user 104 via the touchscreen 106, the hand characteristic(s) and usage pattern(s) are sent to the identity determiner 302. The identity determiner 302 sends the hand characteristics to the database 208 for storage in association with the user identifier. Subsequently, the identity determiner 302 uses the hand characteristics captured and/or determined by the fingerprint identifier 306, the fingertip size/shape identifier 308, the cadence tracker 310, and/or the pattern tracker 312 to automatically identify the user 104 as the user 104 is interacting with the computing device 102 for other purposes.

As the software meter running on the computing device 102 collects activity data (e.g., media identification data) representative of activity of the user 104 on the computing device 102 (e.g., as the user 104 operates the computing device 102), the user identification logic 202 detects hand characteristic(s) and/or usage pattern(s) of the user 104 using the sensor(s) 204. As the user 104 types on the touchscreen 106 of the computing device 102, the sensor(s) 204 of the illustrated example detect images representative of the finger(s) of the user 104 and send them to the fingerprint identifier 306, the fingertip size/shape identifier 308, the cadence tracker 310, and/or the pattern tracker 312 to collect and/or determine the hand characteristic(s) and/or usage pattern(s) of the user 104. The images may be timestamped to facilitate determinations of the typing cadence and/or typing pattern. The fingerprint identifier 306 of the illustrated example processes the images to collect a fingerprint. The fingertip size/shape identifier 308 of the illustrated example processes the images to collect a fingertip shape and/or size. The cadence tracker 310 of the illustrated example processes the images to collect a typing cadence. The pattern tracker 312 of the illustrated example processes the images to determine a typing pattern (e.g., a finger usage pattern).

The fingerprint identifier 306, the fingertip size/shape identifier 308, the cadence tracker 310, and the pattern tracker 312 of the illustrated example attempt to identify the user 104 by determining if the collected hand characteristic(s) and/or usage pattern(s) are known. The fingerprint identifier 306, the fingertip size/shape identifier 308, the cadence tracker 310, and the pattern tracker 312 determine if collected hand characteristic(s) and/or usage pattern(s) are known by attempting to match collected hand characteristic(s) and/or usage pattern(s) with reference hand characteristic(s) and/or reference usage pattern(s) stored in the database 208 (e.g., hand characteristics and/or usage patterns that were collected and associated with a user during the registration process and/or subsequently). The reference hand characteristics(s) and/or reference usage pattern(s) stored in the database 208 are accessed by the fingerprint identifier 306, the fingertip size/shape identifier 308, the cadence tracker 310, and/or the pattern tracker 312 via the identity determiner 302. The matching process may involve, for example, converting images into signatures and matching the signatures and/or representing portion(s) of the image(s) as vectors and matching the vectors. Any other image representation and/or matching technologies may additionally or alternatively be used.

In the illustrated example, the user identification logic 202 uses the counters 314 to identify the user 104 based on the collected hand characteristic(s) and/or usage pattern(s). To determine if the collected fingerprint is known, the fingerprint identifier 306 compares the collected fingerprint to reference fingerprints stored in the database 208. If the collected fingerprint is substantially similar, for example, to a stored fingerprint, the fingerprint identifier 306 determines that the collected fingerprint is known and increments a fingerprint counter 314 for a user corresponding to the matching reference fingerprint.

The fingertip size/shape identifier 308 determines if the fingertip size and/or shape of the collected fingerprint is known. To determine if the collected fingertip size and/or shape is known, the fingertip size/shape identifier 308 compares the collected fingertip size and/or shape to reference fingertip sizes and/or shapes stored in the database 208. If the collected fingertip size and/or shape is substantially similar to a stored fingertip size and/or shape, the fingertip size/shape identifier 308 determines that the collected fingertip size and/or shape is known and increments a fingertip size/shape counter 314 for a user corresponding to the matching reference fingertip size and/or shape.

The cadence tracker 310 determines if the typing cadence is known. To determine if the typing cadence is known, the cadence tracker 310 compares the determined typing cadence to typing cadences stored in the database 208. If the determined cadence is substantially similar to a stored cadence, the cadence tracker 310 determines that the determined typing cadence is known and increments a cadence counter 314 for a user corresponding to the matching reference cadence.

The pattern tracker 312 determines if the typing pattern is known. A typing pattern may be, for example, a number of fingers used by the user 104 to type on the touchscreen 106. To determine if the determined typing pattern is known, the pattern tracker 312 compares the determined typing pattern to reference typing patterns stored in the database 208. If the determined pattern is substantially similar to a stored pattern, the pattern tracker 312 determines that the determined typing pattern is known and increments a pattern counter 314 for a user corresponding to the matching reference typing pattern.

Once the fingerprint identifier 306, the fingertip size/shape identifier 308, the cadence tracker 310, and the pattern tracker 312 have evaluated the collected hand characteristic(s) and/or usage pattern(s) and incremented the corresponding counters, the identity determiner 302 sums the counters 314 for each corresponding user. For example, the fingerprint counter 314, the fingertip size/shape counter 314, and the cadence counter 314 may each have been incremented for a first user and the pattern counter 314 may have been incremented for a second user. The identity determiner 302 sums the counters 314 for the first and second user and determines that the first user has a sum of ‘3” and the second user has a sum of “1.” Once the identity determiner 302 sums the counters 314 for each corresponding user, the identity determiner 302 determines that the identity of the user 104 is the user with the highest total count. In the above example, the first user has a larger total count than the second user and, thus, the identity determiner 302 determines that the identity of the user 104 is the first user.

In some examples, the counters are weighted. For instance, if fingerprints are considered more reliable than typing cadence, the typing cadence counter may be multiplied by a value less than one prior to the summation of the counters to reduce the impact of the cadence counter on the final determination relative to the fingerprint counter. In some examples, the final counts are compared to a threshold (e.g., five) and if no counter has a total count above the threshold, the determination is considered inconclusive. In such circumstances, the identification process may be restarted (with or without resetting the counters) and/or the user may be prompted to self-identify on a pop-up login window. Any data collected can then be added to the database 208 for the self-identified user (who may be a new user) to facilitate improved passive identification in the future.

Once the identity determiner 302 of the illustrated example determines the identity of the user 104, the identity determiner 302 clears the counters in preparation for another user identification attempt and sends the identifier of the user 104 (e.g., the user identifier stored in association with the corresponding hand characteristic(s) and/or usage pattern(s)) to the timestamper 212 to be timestamped. The identifier is associated with corresponding activity data (e.g., media identification data), stored, and/or exported to a central facility (e.g., the central facility 108) for further processing.

While the user identification logic 202 has been illustrated in FIG. 3, one or more of the elements, processes and/or devices illustrated in FIG. 3 may be combined, divided, re-arranged, omitted, eliminated and/or implemented in any other way. Further, the identity determiner 302, the registrar 304, the fingerprint identifier 306, the fingertip size/shape identifier 308, the cadence tracker 310, the pattern tracker 312, the counter(s) 314, and/or, more generally, the example user identification logic 202 of FIG. 3 may be implemented by hardware, software, firmware and/or any combination of hardware, software and/or firmware. Thus, for example, any of the example identity determiner 302, the registrar 304, the fingerprint identifier 306, the fingertip size/shape identifier 308, the cadence tracker 310, the pattern tracker 312, the counter(s) 314, and/or, more generally, the example user identification logic 202 of FIG. 3 could be implemented by one or more circuit(s), programmable processor(s), ASIC(s), PLD(s) and/or FPLD(s), etc. When any of the apparatus or system claims of this patent are read to cover a purely software and/or firmware implementation, at least one of the example identity determiner 302, the registrar 304, the fingerprint identifier 306, the fingertip size/shape identifier 308, the cadence tracker 310, the pattern tracker 312, and/or the counter(s) 314 are hereby expressly defined to include a tangible computer readable medium such as a memory, DVD, CD, Blu-ray, etc. storing the software and/or firmware. Further still, the example user identification logic 202 of FIG. 3 may include one or more elements, processes and/or devices in addition to, or instead of, those illustrated in FIG. 3, and/or may include more than one of any or all of the illustrated elements, processes and devices.

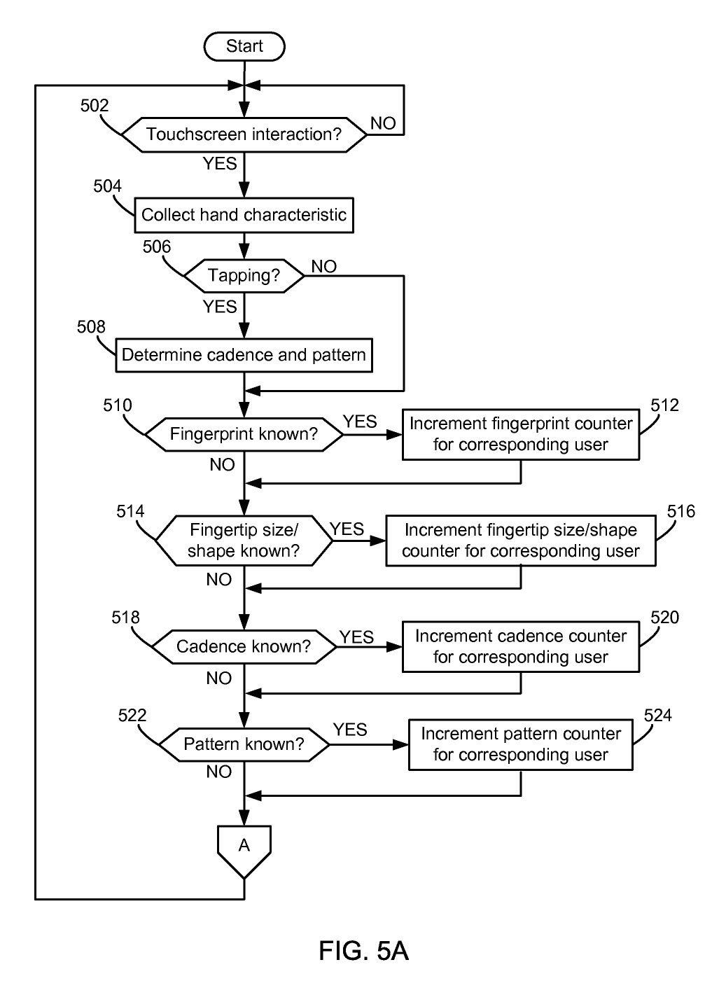

Flowcharts representative of example machine readable instructions for implementing the example computing device 102 of FIG. 2 and/or the example user identification logic 202 of FIG. 3 are shown in FIGS. 4, 5, and 6. In these examples, the machine readable instructions comprise a program for execution by a processor such as the processor 712 shown in the example processor platform 700 discussed below in connection with FIG. 7. The program may be embodied in software stored on a tangible computer readable medium such as a compact disc read-only memory (“CD-ROM”), a floppy disk, a hard drive, a DVD, Blu-ray disk, or a memory associated with the processor 712, but the entire program and/or parts thereof could alternatively be executed by a device other than the processor 712 and/or embodied in firmware or dedicated hardware. Further, although the example program is described with reference to the flowcharts illustrated in FIGS. 4, 5, and 6, many other methods of implementing the example computing device 102 and/or the example user identification logic 202 may alternatively be used. For example, the order of execution of the blocks may be changed, and/or some of the blocks described may be changed, eliminated, or combined.

As mentioned above, the example processes of FIGS. 4, 5, and 6 may be implemented using coded instructions (e.g., computer readable instructions) stored on a tangible computer readable medium such as a hard disk drive, a flash memory, a read-only memory (“ROM”), a CD, a DVD, a Blu-ray disk, a cache, a random-access memory (“RAM”) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 4, 5, and 6 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 4 is a flow diagram representative of example machine readable instructions that may be executed to implement the example computing device 102 of FIG. 2 and/or the example user identification logic 202 of FIG. 3 to register a user (e.g., the user 104) for participation in an audience measurement panel.

When the user 104 agrees to participate in an audience measurement panel, the user 104 is required to complete a registration process. During the registration process, the registrar 304 prompts the user 104 (via, for example, display on the touchscreen 106, audible instructions output by a speaker, flashing lights, etc.) to input a user identifier (block 402). The user 104 enters the user identifier via the touchscreen 106 and the registrar 304 receives the identifier (block 404). The registrar 304 passes the identifier to the identity determiner 302 and the identity determiner 302 passes the identifier to a database (e.g., the database 208 of FIG. 2) for storage (e.g., locally with the computing device and/or remotely at the central facility). Storing the data at the central facility has the advantage of allowing the identifier to be used to identify the user(s) on more than one computing device.

Once the user 104 has entered the identifier via the touchscreen 106, the registrar 304 prompts the user 104 to enter one or more hand characteristic(s) and/or usage pattern(s) (block 406). For example, the registrar 304 prompts the user 104 to input a fingerprint (see FIG. 3A), multiple fingerprints, a typing sample, etc. using the touchscreen 106 of the computing device 102. The sensor(s) 204 capture the one or more hand characteristic(s) and/or usage pattern(s) via the touchscreen 106 and pass them to the fingerprint identifier 306, the fingertip size/shape identifier 308, the cadence tracker 310, and/or the pattern tracker 312 to collect and/or determine the hand characteristic(s) and/or usage pattern(s) of the user 104 (block 408). For example, the fingerprint identifier 306 determines the fingerprint of the user 104. The fingertip size/shape identifier 308 determines the fingertip size and/or shape of the user 104. The cadence tracker 310 analyzes the captured hand characteristic(s) and/or usage pattern(s) to determine a typing cadence to be associated with the user 104. The pattern tracker 312 analyzes the captured hand characteristic(s) and/or usage pattern(s) to determine a typing pattern to be associated with the user 104.

Once the fingerprint identifier 306, the fingertip size/shape identifier 308, the cadence tracker 310, and the pattern tracker 312 have collected and/or determined the hand characteristic(s) and/or usage pattern(s) of the user 104, the fingerprint identifier 306, the fingertip size/shape identifier 308, the cadence tracker 310, and the pattern tracker 312 send the collected hand characteristic(s) and/or usage pattern(s) to the identity determiner 302. The identity determiner 302 sends the collected hand characteristic(s) and/or usage pattern(s) to the database 208 for storage in association with the user identifier of the user 104 (block 410). Thereafter, the user identification logic 202 uses the hand characteristic(s) and/or usage pattern(s) collected during the registration process to identify the user 104 as the user 104 is interacting with the computing device 102 for other purposes (e.g., not self-identifying).

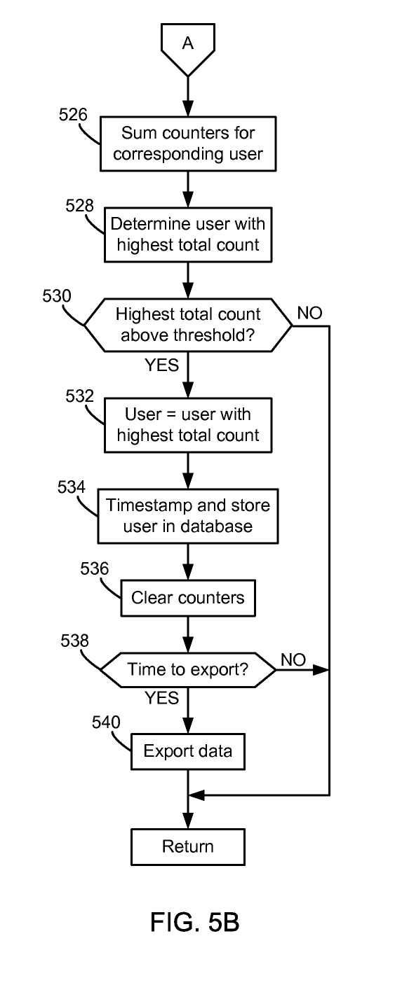

FIG. 5 is a flow diagram representative of example machine readable instructions that may be executed to implement the example computing device 102 of FIG. 2 and the user identification logic 202 of FIG. 4 to identify a user (e.g., the user 104 of FIG. 1) participating in an audience measurement panel. The user identification logic 202 of the computing device 102 passively collects hand characteristic(s) and/or usage pattern(s) of the user 104 as the software meter running on the computing device 102 collects activity data (e.g., media identification data) representative of activity of the user 104 on the computing device 102 (e.g., as the user 104 operates the computing device 102).

Initially, the user identification logic 202 determines if there is touchscreen 106 interaction (e.g., if the user 104 is using the touchscreen 106) using the sensor(s) 204 (block 502). For example, if the sensor(s) 204 detect a fingerprint and/or typing, the user identification logic 202 determines that there is touchscreen 106 interaction. If there is no touchscreen 106 interaction, control remains at block 502 until there is such interaction.

Once the user identification logic 202 detects touchscreen 106 interaction, the user identification logic 202 collects hand characteristic(s) and/or usage pattern(s) of the user 104 (block 504) using the sensor(s) 204. As the user 104 types on the touchscreen 106 of the computing device 102, the sensor(s) 204 collect hand characteristic(s) and/or usage pattern(s) and pass them to the fingerprint identifier 306, the fingertip size/shape identifier 308, the cadence tracker 310, and/or the pattern tracker 312. The fingerprint identifier 306 of the illustrated example analyzes the captured images to attempt to collect a fingerprint. The fingertip size/shape identifier 308 of the illustrated example analyzes the captured images to attempt to collect a fingertip shape and/or size. The cadence tracker 310 and the pattern tracker 312 analyze the captured images to attempt to determine if there is a cadence or other usage pattern created by the interaction with the touchscreen 106 (block 506). If the user 104 is tapping on the touchscreen 106, the cadence tracker 310 determines a typing cadence and the pattern tracker 312 determines a typing pattern (block 508).

The fingerprint identifier 306, the fingertip size/shape identifier 308, the cadence tracker 310, and the pattern tracker 312 of the illustrated example attempt to facilitate identification of the user 104 by attempting to match collected hand characteristic(s) and/or usage pattern(s) with reference hand characteristic(s) and/or reference usage pattern(s) stored in the database 208. In the illustrated example, the user identification logic 202 uses the counters 314 to identify the user 104 based on the collected hand characteristic(s) and/or usage pattern(s).

To begin the matching process, the fingerprint identifier 306 determines if a collected fingerprint is known (block 510). To determine if the collected fingerprint is known, the fingerprint identifier 306 compares the collected fingerprint to reference fingerprints stored in the database 208. If the collected fingerprint is substantially similar, for example, to a stored fingerprint, the fingerprint identifier 306 increments a fingerprint counter 314 for a corresponding user (block 512). If the fingerprint is not known, control proceeds to block 514 without incrementing a counter.

The fingertip size/shape identifier 308 determines if the fingertip size and/or shape of the collected fingerprint is known (block 514). To determine if the collected fingertip size and/or shape is known, fingertip size/shape identifier 308 compares the collected fingertip size and/or shape to reference fingertip sizes and/or shapes stored in the database 208. If the collected fingertip size and/or shape is substantially similar to a stored fingertip size and/or shape, the fingertip size/shape identifier 308 determines that the collected fingertip size and/or shape is known and increments a fingertip size counter 314 and/or a fingertip shape counter 314 for a corresponding user (block 516). If the fingertip size and/or shape is not known, control proceeds to block 518 without incrementing a counter.

The cadence tracker 310 determines if the typing cadence is known (block 518). To determine if the determined typing cadence is known, the cadence tracker 310 compares the determined typing cadence to reference typing cadences stored in the database 208. If the determined cadence is substantially similar to a stored cadence, the cadence tracker 310 increments a cadence counter 314 for a corresponding user (block 520). If the typing cadence is not known, control proceeds to block 522 without incrementing a counter.

The pattern tracker 312 determines if the typing pattern is known (block 522). To determine if the determined typing pattern is known, the pattern tracker 312 compares the determined typing pattern to reference typing patterns stored in the database 208. If the determined pattern is substantially similar to a stored pattern, the pattern tracker 312 increments a pattern counter 314 for a corresponding user (block 524). If the typing pattern is not known, control proceeds to block 526 without incrementing a counter.

Once the fingerprint identifier 306, the fingertip size/shape identifier 308, the cadence tracker 310, and the pattern tracker 312 have evaluated the collected hand characteristic(s) and/or usage pattern(s) (e.g., the fingerprint, fingertip size/shape, typing cadence, typing pattern, etc.), a threshold number of tracks (e.g., performed X number of evaluations, and/or a predetermined amount of time has passed (e.g., one minute)), the identity determiner 302 sums the counters for each corresponding user (block 526). In some examples, the counters are weighted. For instance, if fingerprints are considered more reliable than typing cadence, the typing cadence counter may be multiplied by a value less than one prior to the summation of the counters to reduce the impact of the cadence counter on the final determination relative to the fingerprint counter.

Once the identity determiner 302 sums the counters 314 for each corresponding user, the identity determiner 302 determines the user with the highest total count (block 528). The identity determiner 302 then compares the highest total count to a threshold (block 530). In the illustrated example, if the highest total count is not above the threshold (e.g., five), the identification determination is considered inconclusive and control returns to block 502 and the user identification logic 202 continues to collect hand characteristics to identify the user 104. In the illustrated example, the identification process is restarted without resetting the counters. In other examples, the identification process may be restarted after resetting the counters. In some examples, the user may be prompted to self-identify on a pop-up login window. In such examples, any data collected can then be added to the database 208 for the self-identified user (who may be a new user) to facilitate improved passive identification in the future.

If the highest total count is above the threshold, the identity determiner 302 determines that the identity of the user 104 is the user with the highest total count (block 532). Once the identity determiner 302 of the illustrated example determines the identity of the user 104, the identity determiner 302 passes the identifier of the user 104 to the timestamper 212 to be timestamped and the timestamper 212 passes the identifier to the database 208 to be stored (block 534). The identity determiner 302 then clears the counters 314 (block 536).

The exporter 214 receives the identifier from the database 208 and uses the timer 216 to determine if it is time to export data to the central facility 108 (block 538). If the timer 216 has lapsed indicating it is time to export the data, the exporter 214 exports the user identifier and/or collected activity data (e.g., media identification data) to the central facility 108 (block 540). If the timer 216 has not lapsed, control returns to block 502 and the user identification logic 202 continues to collect hand characteristics to identify the user 104.

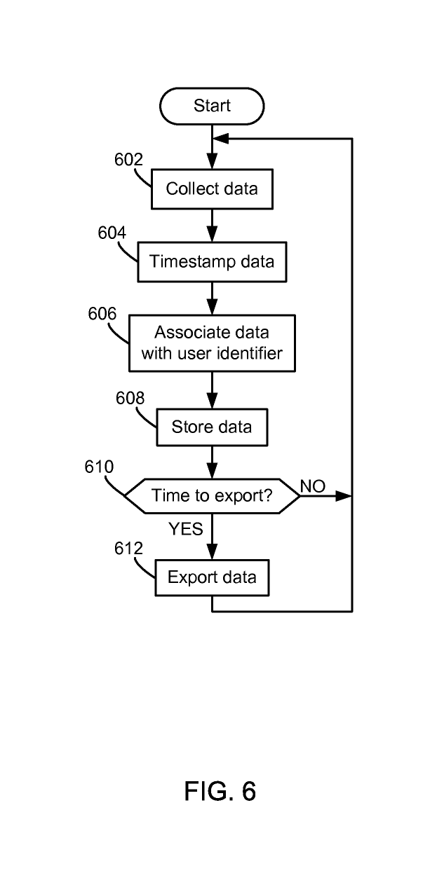

FIG. 6 is a flow diagram representative of example machine readable instructions that may be executed to implement the example computing device 102 of FIG. 2 to collect activity data from the computing device 102. The computing device 102 monitors and/or collects activity data (e.g., media identification data) related to, for example, Internet activity, application use, etc. based on interaction of the user 104 with the computing device 102.

The activity data collector 210 of the illustrated example monitors activity of the user 104 on the computing device 102. The activity data collector 210 may monitor, for example, Internet activity (e.g., URLs visited, web pages visited, etc.), data sent and/or received, games played, media viewed, applications downloaded, advertisements selected, etc. The activity data collector 210 of the illustrated example collects data related to the activity of the user 104 (block 602) and passes the collected data to the timestamper 212. The timestamper 212 of the illustrated example timestamps the collected activity data (block 604) and passes the collected activity data to the database 208. The database 208 associates collected activity data with the identifier of the user 104 determined by the user identification logic 202 (block 606) based on their respective timestamps. For example, activity data collected at a certain time is determined to be associated with the user 104 identified at that same time. The database 208 stores the collected activity data in connection with the corresponding user identifier (block 608). The database 208 of the illustrated example passes the timestamped activity data and the timestamped corresponding user identifier to the exporter 214. The exporter 214 receives the activity data and the user identifier from the database 208 and uses the timer 216 to determine if it is time to export data to the central facility 108 (block 610). If the timer 216 has lapsed indicating it is time to export the data, the exporter 214 exports the user identifier and/or collected activity data to the central facility 108 (block 612). If the timer 216 has not lapsed, control returns to block 602 and the activity data collector 210 continues to collect activity data of the user 104.

FIG. 7 is a block diagram of an example processor platform 700 capable of executing the instructions of FIGS. 4, 5, and/or 6 to implement the example computing device of FIG. 2, the example user identification logic of FIG. 3, and/or, more generally, the example system of FIG. 1. The processor platform 700 can be, for example, a server, a personal computer, an Internet appliance, a set top box, or any other type of computing device.

The processor platform 700 of the instant example includes a processor 712. For example, the processor 712 can be implemented by one or more microprocessors or controllers from any desired family or manufacturer. The processor 712 includes a local memory 713 (e.g., a cache) and is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller.

The processor platform 700 also includes an interface circuit 720. The interface circuit 720 may be implemented by any type of interface standard, such as an Ethernet interface, a universal serial bus (USB), and/or a PCI express interface.

One or more input devices 722 are connected to the interface circuit 720. The input device(s) 722 permit a user to enter data and commands into the processor 712. The input device(s) can be implemented by, for example, a keyboard, a mouse, a touchscreen, a track-pad, a trackball, isopoint and/or a voice recognition system.

One or more output devices 724 are also connected to the interface circuit 720. The output devices 724 can be implemented, for example, by display devices (e.g., a liquid crystal display, a cathode ray tube display (CRT), etc.). The interface circuit 720, thus, typically includes a graphics driver card.

The interface circuit 720 also includes a communication device such as a modem or network interface card to facilitate exchange of data with external computers via a network 726 (e.g., an Ethernet connection, a digital subscriber line (DSL), a telephone line, coaxial cable, a cellular telephone system, etc.).

The processor platform 700 also includes one or more mass storage devices 728 for storing software and data. Examples of such mass storage devices 728 include floppy disk drives, hard drive disks, compact disk drives and digital versatile disk (DVD) drives. The mass storage device 728 may implement a local storage device.

The coded instructions 732 of FIGS. 4, 5, and/or 6 may be stored in the mass storage device 728, in the local memory 713, in the volatile memory 714, in the non-volatile memory 716, and/or on a removable storage medium such as a CD or DVD.

Although certain example methods, systems, apparatus, and articles of manufacture have been described herein, the scope of coverage of this patent is not limited thereto. On the contrary, this patent covers all methods, systems and articles of manufacture fairly falling within the scope of the claims of this patent.

What is claimed is:

1. A method of identifying a user comprising:
capturing a characteristic of a hand of a user via a sensor on a computing device, the characteristic being captured as the user touches the computing device for a purpose different from user identification;
determining an identifier associated with the user based on the captured characteristic; and
exporting the identifier to a collection site.

2. The method of claim 1, wherein the characteristic of the user is a physical characteristic, and the characteristic comprises at least one of a fingerprint, a palm print, a shape of one end of a finer, a size of one end of a finger, a shape of a fingertip, or a size of a fingertip.

3. The method of claim 1, wherein the computing device comprises at least one of a mobile device, a tablet computer, a touchscreen device or a touchless touchscreen device.

4. The method of claim 1, wherein the sensor comprises a camera.

5. The method of claim 1, further comprising:
collecting measurement data via the computing device, the measurement data being representative of the user's activity on the mobile device; and
exporting the measurement data to the collection site.

6. The method of claim 5, further comprising associating the measurement data with the identifier of the user.

7. A system to identify a user comprising:
a sensor to capture a characteristic of a hand of a user, the characteristic being captured as the user touches a computing device for a purpose different from user identification; and
a user identifier to determine an identifier associated with the user based on the characteristic.

8. The system of claim 7, wherein the characteristic of the user is a physical characteristic, and the characteristic comprises at least one of a fingerprint, a palm print, a shape of one end of a finer, a size of one end of a finger, a shape of a fingertip, or a size of a fingertip.

9. The system of claim 8, wherein the computing device comprises at least one of a mobile device, a tablet computer, a touchscreen device or a touchless touchscreen device.

10. The system of claim 8, wherein the sensor comprises a camera.

11. The system of claim 8, further comprising:
an activity data collector to collect measurement data via the computing device, the measurement data being representative of the user's activity on the computing device.

12. The system of claim 11, further comprising an exporter to export the measurement data to a collection site.

13. The system of claim 11, further comprising a database to associate the measurement data with the identifier of the user.

14. A tangible computer-readable medium comprising instructions that, when executed, cause a computing device to at least:
capture a characteristic of a hand of a user via a sensor on a computing device, the characteristic being captured as the user touches the computing device for a purpose different from user identification;
determine an identifier associated with the user based on the captured characteristic; and
export the identifier to a collection site.

15. The computer-readable medium of claim 14, wherein the characteristic of the user is a physical characteristic, and the characteristic comprises at least one of a fingerprint, a palm print, a shape of one end of a finer, a size of one end of a finger, a shape of a fingertip, or a size of a fingertip.

16. The computer-readable medium of claim 14, wherein the computing device comprises at least one of a mobile device, a tablet computer, a touchscreen device or a touchless touchscreen device.

17. The computer-readable medium of claim 14, wherein the sensor comprises a camera.

18. The computer-readable medium of claim 14, further comprising instructions that cause the computing device to:
collect measurement data via the computing device, the measurement data being representative of the user's activity on the mobile device; and
export the measurement data to the collection site.

19. The computer-readable medium of claim 18, further comprising instructions that cause the computing device to associate the measurement data with the identifier of the user.
